(19) United States
(12) Patent Application Publication
(10) Pub. No.: US 2011/0157157 A1
(43) Pub. Date: Jun. 30, 2011

(54) SYSTEM AND METHOD FOR DISPLAYING A THREE-DIMENSIONAL OBJECT

(75) Inventors: CHIH-KUANG CHANG, Tu-Cheng (TW); XIN-YUAN WU, Shenzhen City (CN); XIAO-CHAO SUN, Shenzhen City (CN); MIN WANG, Shenzhen City (CN); JIN-BO HU, Shenzhen City (CN)

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/830,429

(22) Filed: Jul. 5, 2010

(30) Foreign Application Priority Data
Dec. 24, 2009 (CN) 200910312165.1

(51) Int. Cl. G06T 15/00

(52) U.S. Cl. 345/419

(57) ABSTRACT

In a method for displaying a three-dimensional object, a pixel value matrix and a projection depth matrix are created, coordinates of the object are read according to a B-spline curve, and a triangle mesh model is created according to the coordinates. A triangle is selected from the triangle mesh model one by one, so as to obtain coordinates of vertexes of the selected triangle, convert the coordinates of the vertexes to two-dimensional, and generate a figure according to the two-dimensional coordinates. A projection depth of the selected triangle is computed and colors of the selected triangle are added to the figure if the computed projection depth is less than a corresponding projection depth recorded in the projection depth matrix. The pixel value matrix and the projection depth matrix are updated and a two-dimension image formed by elements of two matrixes is outputted onto a display screen.

### BACKGROUND

1. Technical Field

Embodiments of the present disclosure generally relate to image processing systems and methods, and more particularly to a system and method for displaying a three-dimensional object on a display screen.

2. Description of Related Art

Computer aided design (CAD) can be used to design three-dimensional (3D) objects. The 3D objects are being expressed using mathematics formulas or free-form surfaces, such as B-spline curve, in CAD. In order to display a 3D object through a display screen of an electronic device, such as a computer, an image of the 3D object needs to be drawn. It may be understood that, an ordinary display screen can only display two-dimensional (2D) images, thus, it is necessary to convert 3D images to 2D images. Accordingly, how to convert 3D images to 2D images quickly and accurately is necessary.

### BRIEF DESCRIPTION OF THE DRAWINGS

FIG. 1 is a block diagram of one embodiment of a system for displaying a three-dimensional object.

FIG. 2 is a block diagram of functional modules of an image processing unit in FIG. 1.

FIG. 3 shows an example of a triangular mesh model.

FIG. 4 shows an example of a projection depth of a three-dimensional triangle.

FIG. 5 is a flowchart illustrating one embodiment of a method for displaying a three-dimensional object.

### DETAILED DESCRIPTION

The disclosure is illustrated by way of examples and not by way of limitation in the figures of the accompanying drawings in which like references indicate similar elements. It should be noted that references to “an” or “one” embodiment in this disclosure are not necessarily to the same embodiment, and such references mean at least one.

In general, the word “module,” as used hereinafter, refers to logic embodied in hardware or firmware, or to a collection of software instructions, written in a programming language, such as, for example, Java, C, or assembly. One or more software instructions in the modules may be embedded in firmware. It will be appreciated that modules may comprised connected logic units, such as gates and flip-flops, and may comprise programmable units, such as programmable gate arrays or processors. The modules described herein may be implemented as either software and/or hardware modules and may be stored in any type of computer-readable medium or other computer storage device.

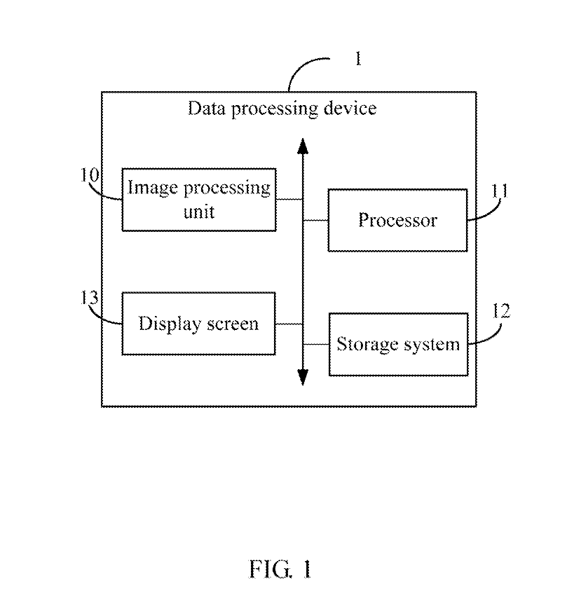

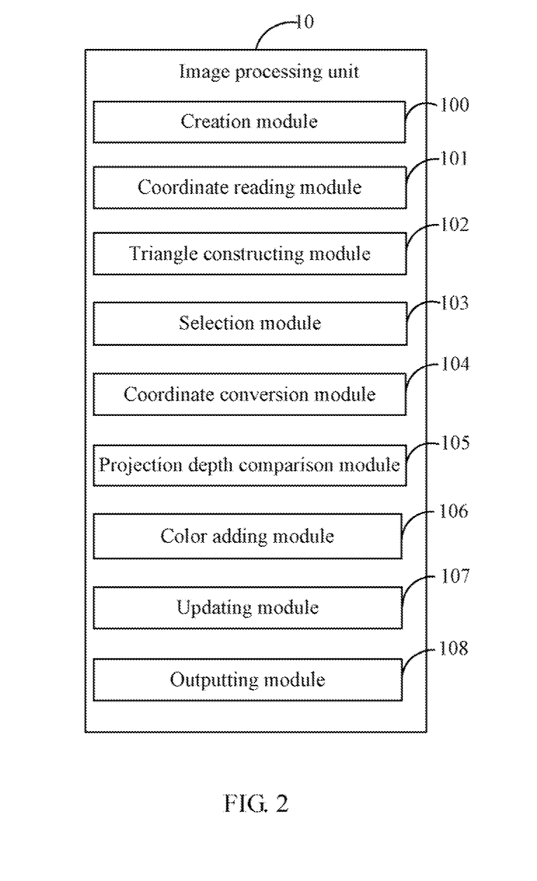

FIG. 1 is a block diagram of one embodiment of a data processing device 1 that can be used to display a three-dimensional object. The data processing device 1 may be a computer system, such as, a personal computer, an application server, or a notebook computer, for example. In one embodiment, the data processing device 1 may include an image processing unit 10, a processor 11, a storage system 12, and a display screen 13. The storage system 12 stores a B-spline curve of the three-dimensional object. The image processing unit 10 includes a plurality of functional modules (see below descriptions referring to FIG. 2), to convert a three-dimensional image of the three-dimensional object into a two-dimensional image, to display the three-dimensional object on the display screen 13. The processor 11 can execute one or more computerized codes of the functional modules of the image processing unit 10. The storage unit 12 further stores the one or more computerized codes of the functional modules of the image processing unit 10. The display screen 13 can display images of the three-dimensional object.

FIG. 2 is a block diagram of the functional modules of the image processing unit 10 in FIG. 1. In one embodiment, the image processing unit 10 includes a creation module 100, a coordinate reading module 101, a triangle constructing module 102, a selection module 103, a coordinate conversion module 104, a projection depth comparison module 105, an color adding module 106, an updating module 107, and an outputting module 108.

The creation module 100 creates a pixel value matrix and a projection depth matrix, and stores the created pixel value matrix and the created projection depth matrix into the storage system 12.

The pixel value matrix is a matrix of pixel values of an image displayed on the display screen 13. The pixel value matrix is used to record a pixel value of each of the pixels of an image displayed on the display screen 13. In one embodiment, each element in the created pixel value matrix is a pixel value of the background color of the display screen, such as the blue. A column and a row of the created pixel value matrix is determined according to a resolution of the display screen 13. For example, if the resolution of the display screen 13 is 1024*768, the column of the created pixel value matrix may be 1024, and the row of the created pixel value matrix may be 768.

The projection depth matrix is a matrix of projection depths of pixels of an image displayed on the display screen 13. The projection depth matrix is used to record a projection depth of each of the pixels of an image displayed on the display screen 13. It may be understood that, the projection depth of a pixel stands for a distance between the pixel and the display screen 13 when the pixel is played on the display screen 13. In one embodiment, each element in the created projection depth matrix is 1. As with the pixel value matrix, a column and a row of the created projection depth matrix is determined according to a resolution of the display screen 13. For example, if the resolution of the display screen 13 is 1024*768, the column of the created projection depth matrix may be 1024, and the row of the created projection depth matrix may be 768.

The coordinate reading module 101 reads three-dimensional coordinates of points of the three-dimensional object according to the B-spline curve stored in the storage system 12.

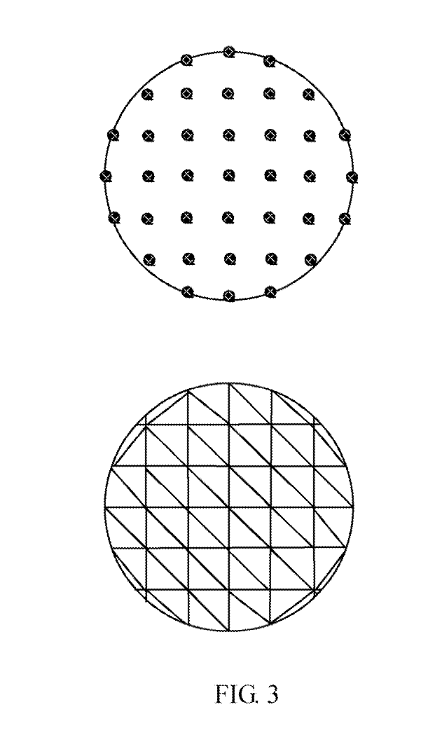

The triangle constructing module 102 creates a triangle mesh model by constructing triangles using the three-dimensional coordinates, as follows, referring to FIG. 3. It should be understood that a triangular mesh model is a type of polygon mesh in computer graphics. A triangular mesh model comprises a set of triangles (typically in three dimensions) that are connected by points located by the three-dimensional coordinates. An example of triangle mesh models is shown in FIG. 3. It may be understood that, the triangles of the triangle mesh model are three-dimensional.

The selection module 103 selects a three-dimensional triangle from the triangle mesh model, and obtains three-dimensional coordinates of vertexes of the selected three-dimensional triangle. The selection of a three-dimensional triangle from the triangle mesh model is repeated until all the three-dimensional triangles of the triangle mesh model have been selected.

The coordinate conversion module 104 converts the three-dimensional coordinates of the vertexes to two-dimensional coordinates by projecting the selected three-dimensional triangle onto the display screen 13, and generates a two-dimensional figure according to the two-dimensional coordinates. It may be understood that, the two-dimensional figure may be a triangle or a line. It may be further understood that, a point located by each two-dimensional coordinate on the display screen 13 corresponds to a pixel of the display screen 13.

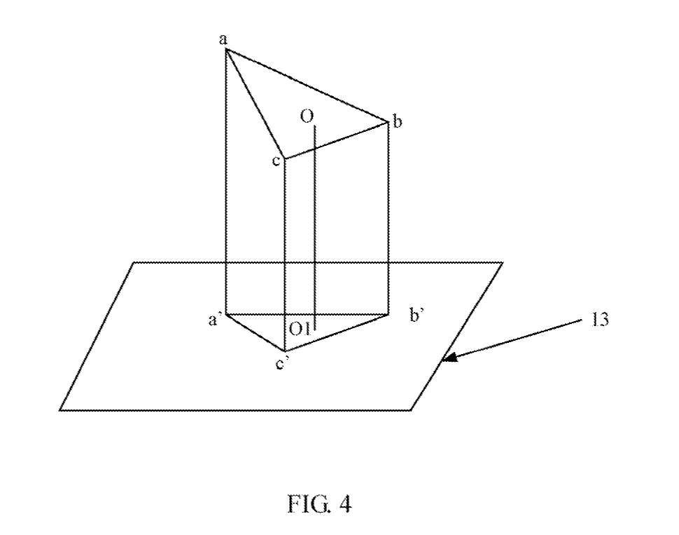

The projection depth comparison module 105 computes a projection depth of the selected three-dimensional triangle by projecting a center of the selected three-dimensional triangle onto the display screen 13 to generate a projected center and obtaining a z-axis coordinate of the projected center. The z-axis coordinate of the projected center is the projection depth of the selected three-dimensional triangle. Referring to FIG. 4 which shows an example of a projection depth of a three-dimensional triangle “abc”, point O (x0, y0, z0) is a center of the three-dimensional triangle “abc”, and point O1 now abandoned (U0, V0, Z0) is the projected center of the point O on the display screen 13, thus, the projection depth of the three-dimensional triangle “abc” is “Z0”.

The color adding module 106 compares the computed projection depth with a projection depth of a pixel, which corresponds to the projected center, of the display screen 13 recorded in the created projection depth matrix, and adds the color of the selected three-dimensional triangle to the two-dimensional FIG. 1f the computed projection depth is less than the projection depth recorded in the created projection depth matrix.

The updating module 107 updates the created pixel value matrix according to the color added to the two-dimensional figure to generate an updated pixel value matrix, and updates the created projection depth matrix according to the computed projection depth to generate an updated projection depth matrix.

The outputting module 108 outputs a two-dimensional image of the three-dimensional object, which is formed according to the elements of the updated pixel value matrix and the updated projection depth matrix, onto the display screen 13.

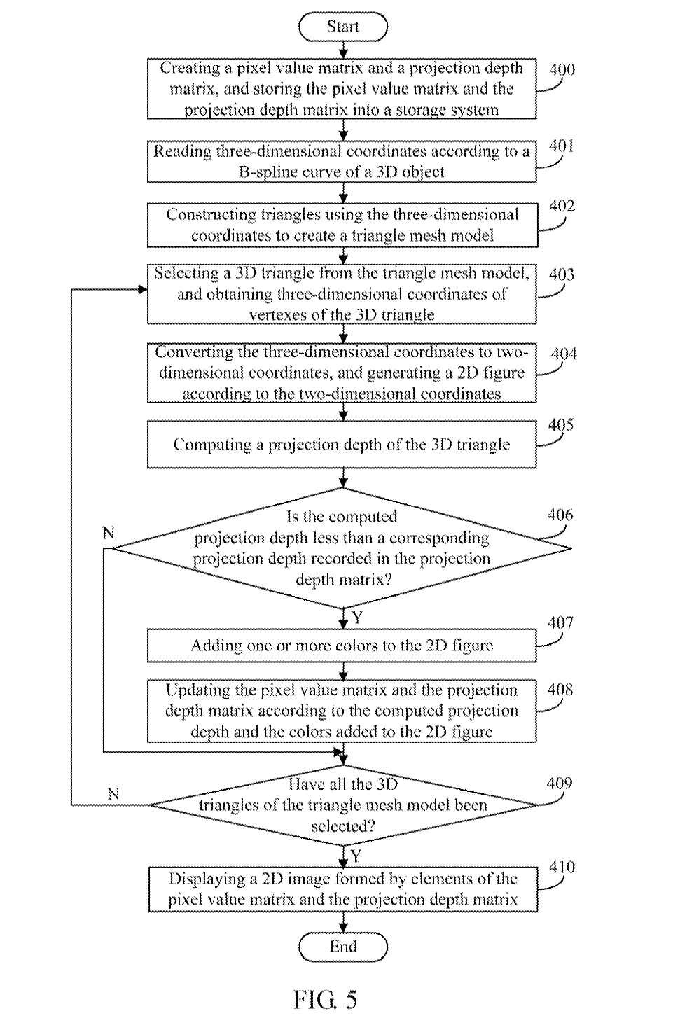

FIG. 5 is a flowchart illustrating one embodiment of a method for displaying a three-dimensional object on the display screen 13. The method can be performed by execution of a computer-readable program code by at least one processor 11 of the data processing device 1. Depending on the embodiment, in FIG. 5, additional blocks may be added, others removed, and the ordering of the blocks may be changed.

In block S400, the creation module 100 creates a pixel value matrix and a projection depth matrix, and stores the created pixel value matrix and the created projection depth matrix into the storage system 12. In one embodiment, each element in the created pixel value matrix is a pixel value of the background color of the display screen 13, such as blue. A column and a row of the created pixel value matrix is determined according to a resolution of the display screen 13. In one embodiment, each element in the created projection depth matrix is 1. A column and a row of the created projection depth matrix is determined according to the resolution of the display screen 13.

In block S401, the coordinate reading module 101 reads three-dimensional coordinates of points of the three-dimensional object according to the B-spline curve stored in the storage system 12.

In block S402, the triangle constructing module 102 creating a triangle mesh model by constructing triangles using the three-dimensional coordinates. A triangular mesh model is a type of polygon mesh in computer graphics. A triangular mesh model comprises a set of triangles (typically in three dimensions) that are connected by points located by the three-dimensional coordinates.

In block S403, the selection module 103 selects a three-dimensional triangle from the triangle mesh model, and obtains three-dimensional coordinates of vertexes of the selected three-dimensional triangle.

In block S404, the coordinate conversion module 104 converts the three-dimensional coordinates of the vertexes to two-dimensional coordinates, and generates a two-dimensional figure according to the two-dimensional coordinates. In one embodiment, the conversion is implemented by projecting the selected three-dimensional triangle onto the display screen 13. It may be understood that, the two-dimensional figure may be a triangle or a line, and a point located by each two-dimensional coordinate on the display screen 13 corresponding to a pixel of the display screen 13.

In block S405, the projection depth comparison module 105 computes a projection depth of the selected three-dimensional triangle. The projection depth of the selected three-dimensional triangle is computed by projecting a center of the selected three-dimensional triangle onto the display screen 13 to generate a projected center, and obtaining a z-axis coordinate of the projected center. The z-axis coordinate of the projected center is the projection depth of the selected three-dimensional triangle.

In block S406, the color adding module 106 determines whether the computed projection depth is less than a projection depth of a pixel, which corresponds to the projected center, of the display screen 13 recorded in the created projection depth matrix. Block S407 is implemented if the computed projection depth is less than the projection depth recorded in the created projection depth matrix. Otherwise, block S409 is implemented if the computed projection depth is equal to or greater than the projection depth recorded in the created projection depth matrix.

In block S407, the color adding module 106 adds the color of the selected three-dimensional triangle to the two-dimensional figure.

In block S408, the updating module 107 updates the created pixel value matrix according to the color added to the two-dimensional figure to generate an updated pixel value matrix, and updates the created projection depth matrix according to the computed projection depth to generate an updated projection depth matrix.

In block S409, the selection module 103 determines whether all the three-dimensional triangles of the triangle mesh model have been selected. Block S403 is repeated if at least one three-dimensional triangle of the triangle mesh model has not been selected. Otherwise, block S410 is implemented if all the three-dimensional triangles of the triangle mesh model have been selected.

In block S410, the outputting module 108 outputs a two-dimensional image of the three-dimensional object, which is formed according to the elements of the updated pixel value matrix and the updated projection depth matrix, onto the display screen 13.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A computer-based method for displaying a three-dimensional object, the method comprising:
(a) creating a pixel value matrix and a projection depth matrix;
(b) reading three-dimensional coordinates of points of the three-dimensional object according to a B-spline curve of the three-dimensional object stored in a storage system, and creating a triangle mesh model by constructing triangles using the three-dimensional coordinates;
(c) selecting a three-dimensional triangle from the triangle mesh model, obtaining three-dimensional coordinates of vertexes of the selected three-dimensional triangle, converting the three-dimensional coordinates to two-dimensional coordinates, and generating a two-dimensional figure according to the two-dimensional coordinates;
(d) computing a projection depth of the selected three-dimensional triangle, and adding the color of the selected three-dimensional triangle to the two-dimensional figure, upon condition that the computed projection depth is less than a corresponding projection depth recorded in the projection depth matrix;
(e) updating the pixel value matrix according to the color added to the two-dimensional figure, and updating the projection depth matrix according to the computed projection depth;
(f) repeating (c) to (e) until all the three-dimensional triangles of the triangle mesh model have been selected; and
(g) outputting a two-dimensional image of the three-dimensional object, which is formed according to elements of the pixel value matrix and the projection depth matrix, onto a display screen.

2. The computer-based method as described in claim 1, after (a) further comprising:
storing the pixel value matrix and the projection depth matrix into the storage system.

3. The computer-based method as described in claim 1, wherein each of the elements in the pixel value matrix when created is a pixel value of the background color of the display screen, and a column and a row of the pixel value matrix is determined according to a resolution of the display screen.

4. The computer-based method as described in claim 1, wherein each of the elements in the projection depth matrix when created is 1, and a column and a row of the pixel value matrix is determined according to a resolution of the display screen.

5. The computer-based method as described in claim 1, wherein the two-dimensional figure is a triangle or a line.

6. The computer-based method as described in claim 1, wherein the projection depth of the selected three-dimensional triangle is computed by projecting a center of the selected three-dimensional triangle onto the display screen to generate a projected center, and obtaining a z-axis coordinate of the projected center.

7. A computer-readable medium having stored thereon instructions that, when executed by at least one processor of a computer, cause the computer to perform method for displaying a three-dimensional object, the method comprising:
(a) creating a pixel value matrix and a projection depth matrix;
(b) reading three-dimensional coordinates of points of the three-dimensional object according to a B-spline curve of the three-dimensional object stored in a storage system, and creating a triangle mesh model by constructing triangles using the three-dimensional coordinates;
(c) selecting a three-dimensional triangle from the triangle mesh model, obtaining three-dimensional coordinates of vertexes of the selected three-dimensional triangle, converting the three-dimensional coordinates to two-dimensional coordinates, and generating a two-dimensional figure according to the two-dimensional coordinates;
(d) computing a projection depth of the selected three-dimensional triangle, and adding the color of the selected three-dimensional triangle to the two-dimensional figure, upon condition that the computed projection depth is less than a corresponding projection depth recorded in the projection depth matrix;
(e) updating the pixel value matrix according to the color added to the two-dimensional figure, and updating the projection depth matrix according to the computed projection depth;
(f) repeating (c) to (e) until all the three-dimensional triangles of the triangle mesh model have been selected; and
(g) outputting a two-dimensional image of the three-dimensional object, which is formed according to elements of the pixel value matrix and the projection depth matrix, onto a display screen.

8. The computer-readable medium as described in claim 7, after (a) the method further comprising:
storing the pixel value matrix and the projection depth matrix into the storage system.

9. The computer-readable medium as described in claim 7, wherein each of the elements in the pixel value matrix when created is a pixel value of a background color of the display screen, and a column and a row of the pixel value matrix is determined according to a resolution of the display screen.

10. The computer-readable medium as described in claim 7, wherein each of the elements in the projection depth matrix when created is 1, and a column and a row of the pixel value matrix is determined according to a resolution of the display screen.

11. The computer-readable medium as described in claim 7, wherein the two-dimensional figure is a triangle or a line.

12. The computer-readable medium as described in claim 7, wherein the projection depth of the selected three-dimensional triangle is computed by projecting a center of the selected three-dimensional triangle onto the display screen to generate a projected center, and obtaining a z-axis coordinate of the projected center.

13. A system for displaying a three-dimensional object on a display screen, the system comprising:
a created module operable to create a pixel value matrix and a projection depth matrix;
a coordinate reading module operable to read three-dimensional coordinates of points of the three-dimensional object according to a B-spline curve of the three-dimensional object stored in a storage system;
a triangle constructing module operable to create a triangle mesh model by constructing triangles using the three-dimensional coordinates;
a selection module operable to select a three-dimensional triangle from the triangle mesh model, and obtain three-dimensional coordinates of vertexes of the selected three-dimensional triangle;
a coordinate conversion module operable to convert the three-dimensional coordinates of the vertexes to two-dimensional coordinates, and generate a two-dimensional figure according to the two-dimensional coordinates;
a projection depth comparison module operable to compute a projection depth of the selected three-dimensional triangle;
a color adding module operable to compare the computed projection depth with a corresponding projection depth recorded in the projection depth matrix, and add the color of the selected three-dimensional triangle to the two-dimensional figure upon condition that the computed projection depth is less than the corresponding projection depth recorded in the projection depth matrix;
an updating module operable to update the pixel value matrix according to the color added to the two-dimensional figure, and update the projection depth matrix according to the computed projection depth; and
an outputting module operable to output a two-dimensional image of the three-dimensional object, which is formed according to elements of the pixel value matrix and the projection depth matrix, onto the display screen.

14. The system as described in claim 13, further comprising:
a processor that executes the creation module, the coordinate reading module, the triangle constructing module, the selection module, the coordinate conversion module, the projection depth comparison module, the color adding module, the updating module, and the outputting module.

15. The system as described in claim 13, wherein the creation module is further operable to store the pixel value matrix and the projection depth matrix into the storage system.

16. The system as described in claim 13, wherein the selection of a three-dimensional triangle from the triangle mesh model is repeated until all the three-dimensional triangles of the triangle mesh model have been selected.

17. The system as described in claim 13, wherein each of the elements in the pixel value matrix when created is a pixel value of a background color of the display screen, and a column and a row of the pixel value matrix is determined according to a resolution of the display screen.

18. The system as described in claim 13, wherein each of the elements in the projection depth matrix when created is 1, and a column and a row of the pixel value matrix is determined according to a resolution of the display screen.

19. The system as described in claim 13, wherein the two-dimensional figure is a triangle or a line.

20. The system as described in claim 13, wherein the projection depth of the selected three-dimensional triangle is computed by projecting a center of the selected three-dimensional triangle onto the display screen to generate a projected center, and obtaining a z-axis coordinate of the projected center.
